(19) United States
(12) Patent Application Publication
(10) Pub. No.: US 2019/0170440 A1
(43) Pub. Date: Jun. 6, 2019

(54) Pressure-Regulated Melting of Solids

(71) Applicants: Larry Baxter, Orem, UT (US); Kyler Stitt, Lindon, UT (US); Christopher Hoeger, Provo, UT (US); Aaron Sayre, Spanish FOrk, UT (US); Jacom Chamberlain, Provo, UT (US); David Frankman, Provo, UT (US); Nathan Davis, Bountiful, UT (US)

(72) Inventors: Larry Baxter, Orem, UT (US); Kyler Stitt, Lindon, UT (US); Christopher Hoeger, Provo, UT (US); Aaron Sayre, Spanish FOrk, UT (US); Jacom Chamberlain, Provo, UT (US); David Frankman, Provo, UT (US); Nathan Davis, Bountiful, UT (US)

(21) Appl. No.: 15/831,782

(22) Filed: Dec. 5, 2017

(51) Int. Cl. F27D 3/00; F27D 3/14; F27D 7/06

(52) U.S. Cl. CPC F27D 3/0025; F27D 3/14; F27D 7/06; F27D 2007/063; F17C 2225/013; F17C 2225/035; F17C 2223/0138

(57) ABSTRACT

Devices, systems, and methods for pressure-regulated melting are disclosed. A vessel includes a solids inlet, a fluids outlet, a cavity, and an energy source. Solids enter the vessel through the solids inlet. The cavity has an internal pressure. A backpressure is induced in the solids inlet. The energy source heats the vessel, the contents of the vessel, or a combination thereof. The rate of heating of the energy source is matched to a feed rate of the solids such that the solids are melted directly to a product liquid at the internal pressure. The product liquid passes through the fluids outlet through a restriction that maintains the internal pressure in the cavity.

### GOVERNMENT INTEREST STATEMENT

This invention was made with government support under DE-FE0028697 awarded by the Department of Energy. The government has certain rights in the invention.

### FIELD OF THE INVENTION

The devices, systems, and methods described herein relate generally to melting of solids. More particularly, the devices, systems, and methods described herein relate to melting of solids that sublimate at ambient pressures.

### BACKGROUND

Cryogenic solids of various varieties have phase diagrams that do not permit transitions between solid and liquid phases at ambient or near-ambient pressures. Handling these materials as solids is a challenge, as they require the solids handling be done under high pressure conditions, which is logistically difficult and costly. Devices, systems, and methods capable of handling cryogenic materials with minimal solids handling would be beneficial.

### SUMMARY

Devices, systems, and methods for pressure-regulated melting are disclosed. A vessel includes a solids inlet, a fluids outlet, a cavity, and an energy source. Solids enter the vessel through the solids inlet. The cavity has an internal pressure. A backpressure is induced in the solids inlet. The energy source heats the vessel, the contents of the vessel, or a combination thereof. The rate of heating of the energy source is matched to a feed rate of the solids such that the solids are melted directly to a product liquid at the internal pressure. The product liquid passes through the fluids outlet through a restriction that maintains the internal pressure in the cavity.

The energy source may comprise a melting device, a warm fluid, or a combination thereof. The solids inlet may include a screw press. The fluids outlet may include a heat exchanger that further heats the product liquid, producing a heated product liquid. The fluids outlet may further include a gas/liquid separator that receives the heated product liquid from the heat exchanger and separates a final product liquid and a product gas. The gas/liquid separator may include a pump that pumps a portion of the final product liquid from the gas/liquid separator to the vessel, the portion of the final product liquid being the warm liquid.

The restriction may be one or more valves. The vessel may have an internal heating element. The solids inlet may include a reducer which induces the backpressure on the solids inlet. The reducer may be a concentric reducer, an eccentric reducer, or a nozzle.

The solids may include water, hydrocarbons, ammonia, solid acid gases, or a combination thereof, and wherein solid acid gases comprise solid forms of carbon dioxide, nitrogen oxide, sulfur dioxide, nitrogen dioxide, sulfur trioxide, hydrogen sulfide, or a combination thereof. The warm liquid may include water, hydrocarbons, liquid ammonia, liquid acid gases, cryogenic liquids, or a combination thereof, and wherein liquid acid gases comprise liquid forms of carbon dioxide, nitrogen oxide, sulfur dioxide, nitrogen dioxide, sulfur trioxide, hydrogen sulfide, or a combination thereof.

### BRIEF DESCRIPTION OF THE DRAWINGS

In order that the advantages of the described devices, systems, and methods will be readily understood, a more particular description of the described devices, systems, and methods briefly described above will be rendered by reference to specific embodiments illustrated in the appended drawings. Understanding that these drawings depict only typical embodiments of the described devices, systems, and methods and are not therefore to be considered limiting of its scope, the devices, systems, and methods will be described and explained with additional specificity and detail through use of the accompanying drawings, in which:

FIG. 1 shows a process flow diagram for melting solids.

FIG. 2 shows an isometric side elevation cutaway view of a vessel and screw press for use in the process of FIG. 1.

FIG. 3 shows a process flow diagram for melting solids.

FIG. 4 shows a process flow diagram for melting solids.

FIG. 5 shows an isometric side-front elevation view of a vessel for use in the process of FIG. 4.

FIG. 6 shows a method for melting solids.

### DETAILED DESCRIPTION

It will be readily understood that the components of the described devices, systems, and methods, as generally described and illustrated in the Figures herein, could be arranged and designed in a wide variety of different configurations. Thus, the following more detailed description of the embodiments of the described devices, systems, and methods, as represented in the Figures, is not intended to limit the scope of the described devices, systems, and methods, as claimed, but is merely representative of certain examples of presently contemplated embodiments in accordance with the described devices, systems, and methods.

Many cryogenic solids act in ways seemingly contradictory to that which is expected for solids. Normally, solids melt into a liquid, which then vaporizes into a gas. Many cryogenic liquids, such as carbon dioxide and other acid gases, have phase diagrams that, at ambient pressures, will sublimate from solid directly to gas. In materials handling, liquids are simple to transport when compared to both solids and gases. Gases typically require large equipment to transport similar masses in comparison to liquid. On the other hand, solids have to be moved by conveyance devices that are, with only a few exceptions, open to ambient pressures. The devices, systems, and methods disclosed herein overcome these challenges by avoiding the issue entirely. Cryogenic solids, or any solids that can be melted, are passed into a vessel against a backpressure and an energy source melts the solids directly to a liquid as they enter the vessel, resulting in a product liquid. This product liquid then leaves the vessel through a restriction, resulting in an internal pressure in the cavity of the vessel, allowing the solids to transition from solid to liquid instead of liquid to gas. This is due to the pressure increase moving the product to a different portion of the phase diagram—specifically, from the pressure at which solids transition by desublimation to gases to the pressure at which solids transition by melting to liquids. The energy source can be a melting device or a warm liquid. The melting device can be a resistance-style heater, or can be a hot liquid in a tube (any indirect-contact heat exchanger). The means by which the solids are passed into the vessel depend entirely upon the solids being passed, whether as fine ‘fluid-like’ solids, or suspended in slurries. Of special note are screw conveyors and peristaltic pumps. Each provides a benefit that traditional systems cannot. In the case of peristaltic pumps, solids are entirely blocked from backing up in the system, and so solids will not be forced backwards. In the case of screw conveyors, specialized filtering screw presses can be used that remove liquids from slurries before forcing the solids into the vessel for melting.

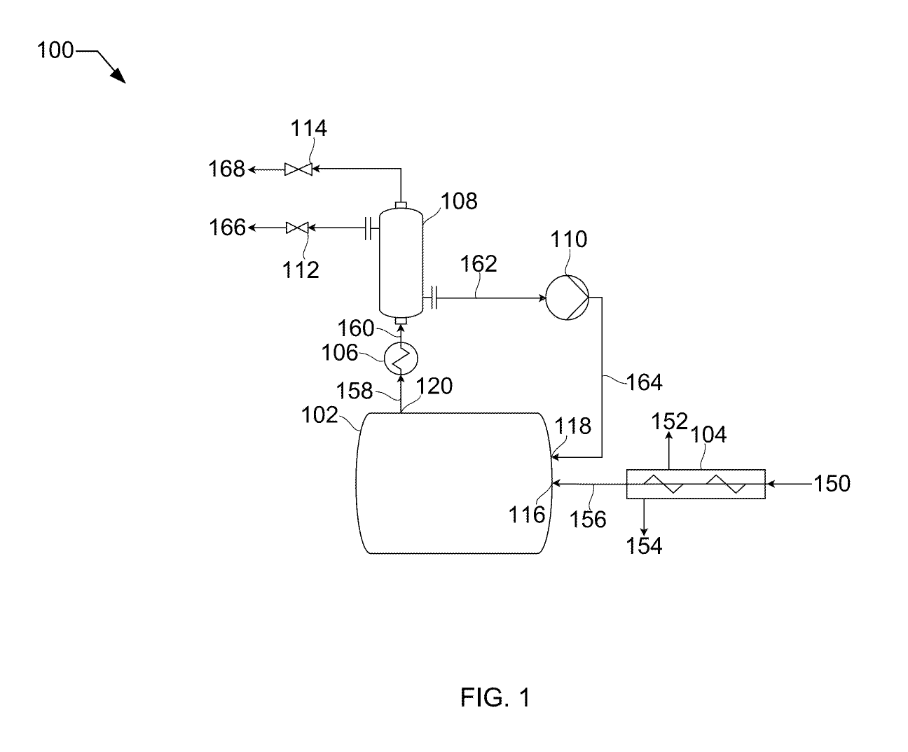

Referring now to the Figures, FIG. 1 shows a process flow diagram 100 for melting solids that may be used in the described devices, systems, and methods. A slurry stream 150 is fed to a filtering screw press 104. The slurry stream 150 consists of a liquid, such as, isopentane, and an entrained solid, such as carbon dioxide. The slurry stream 150 passes through filter screw press 104 and a backpressure on the slurry stream 150 from a solids inlet 116 causes substantially all the liquid to leave the filter screw press 104 as a contact liquid 154. Any gas evolved in the filtering screw press 104 leaves as off-gas stream 152. The solid stream 156, now substantially pure solid carbon dioxide, passes through the solids inlet 116.

The energy source in this example is a warm fluid stream 164 of liquid carbon dioxide. The warm fluid stream 164 passes through the vessel fluids inlet 118 into the vessel 102. The inlet pressure of this warm fluid stream 164 from pump 110 contributes to the backpressure on the solid stream 156 in the solids inlet 116, and therefore on the slurry stream 150 in the filter screw press 104. As the warm fluid stream 164 encounters the solid stream 156, the solid stream 156 is melted, resulting in a first product liquid stream 158. The vessel outlet 120 is restricted, in this case downstream by valves 112 and 114, such that an internal pressure is maintained in the cavity of the vessel 102. The warm fluid stream 164 is pumped into the vessel 102 at a rate that matches the rate required to melt the solid stream 156 and at an inlet pressure that will maintain the internal pressure of the vessel 102 in a range that the solid stream 156 can transition directly from solid to liquid. Deviation from pressure can result in sublimation rather than melting, which can be dangerous and inefficient. Also, impurities, such as isopentane from the filter screw press 104, can be introduced into the vessel 102 if the melting rate and pressure are not balanced.

The first product liquid stream 158 leaves through the vessel outlet 120 and is heated passing through a first heat exchanger 106, resulting in a warmed product stream 160. Warmed product stream 160 enters a gas-liquid separator 108, splitting into a second product liquid stream 166 and a product gas stream 168. Product liquid stream 166 leaves through valve 112 and product gas stream 168 leaves through valve 114. A portion 162 of product liquid stream 166 is diverted through pump 110 and passed into the vessel 102 as the warm fluid 164, as described above.

In other embodiments, a lesser amount of liquid may be removed from the filtering screw press 104, resulting in some contamination of the product liquid stream 158 by the liquid.

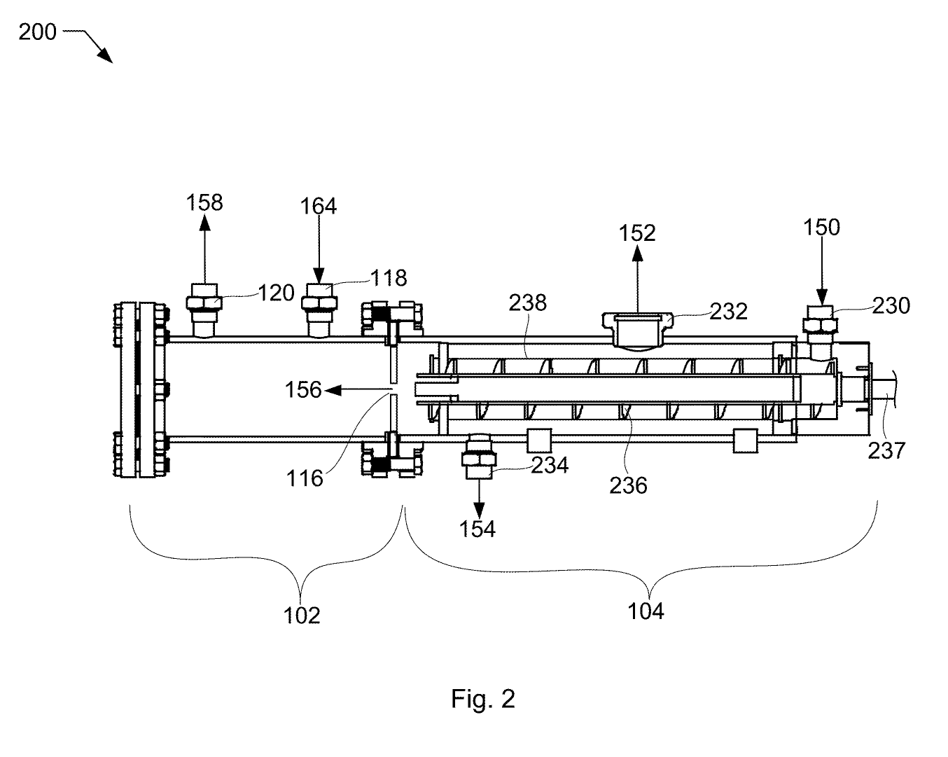

Referring to FIG. 2, FIG. 2 shows an isometric side cutaway elevation view 200 of a vessel and screw press that may be used in the described devices, systems, and methods. In this example, the vessel and screw press may be used in the process of FIG. 1, and will be described accordingly. Vessel 102 includes the solids inlet 116, the vessel fluids inlet 118, and the vessel outlet 120. Filtering screw press 104 includes a screw 236 with a rotor 237, a slurry inlet 230, a filter 238, a gas outlet 232, and a liquid outlet 234. In this case, the outlet for the filtering screw press 104 is the solids inlet 116.

The slurry 150 is conveyed through the filtering screw press 104 by screw 236, driven by rotor 237. The slurry 150 is pushed through the outlet, solids inlet 116. Solids inlet 116 is restricted, in this case, an orifice, resulting in a first back-pressure on the slurry 150 in the screw press that drives the liquid out of the slurry and through the filter 238. The liquid leaves out of the liquid outlet 234 as a substantially pure liquid stream 154. Some portion of the liquid and the solid may leave in the gas phase through gas outlet 232. The solid stream 156 passes through solids inlet 116 and is met by warm fluid stream 164, which melts the solid stream 156 at the rate it enters the vessel 102. The warm fluid stream 164 also provides a portion of the backpressure on the solids inlet. The resultant first product liquid stream 158 passes out the vessel outlet 120, which is restricted, providing the internal pressure on the first product liquid stream 158.

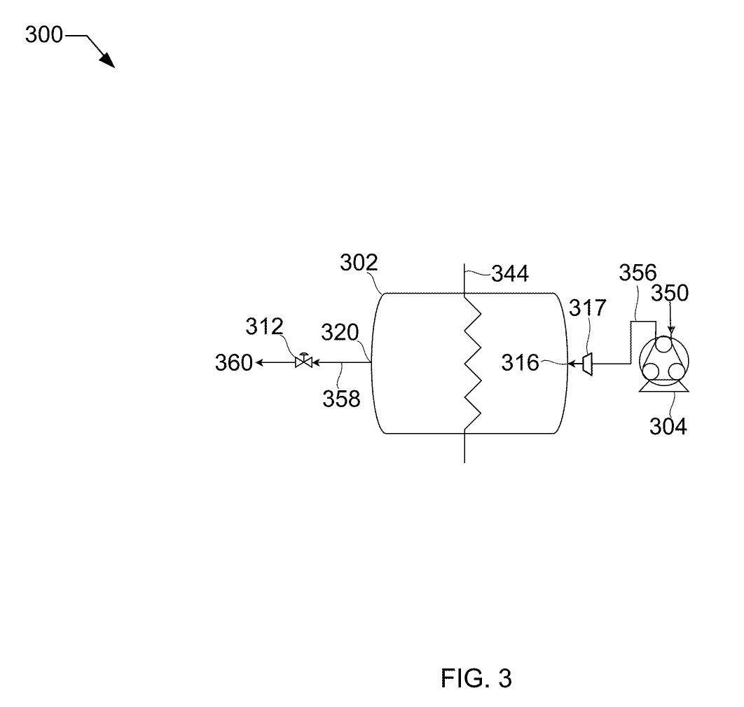

Referring to FIG. 3, FIG. 3 shows a process flow diagram 300 for melting solids that may be used in the described devices, systems, and methods. A solid stream 350 (e.g., 150) is fed to a peristaltic pump 304. The solid stream 350 is of a fine enough particle size that it can be made to “flow” through the peristaltic pump 304. The resultant pressurized solid stream 356 ((e.g., 156) passes through a reducer 317 and into the solids inlet 316 (e.g., 116) into the vessel 302 (e.g., 102). The reducer 317 causes a backpressure on the pressurized solid stream 356. In this example, the solid stream 350 may be a mixture of frozen acid gases and the warm fluid stream 364 may be liquid carbon dioxide. Acid gases include carbon dioxide, nitrogen oxide, sulfur dioxide, nitrogen dioxide, sulfur trioxide, hydrogen sulfide, and other acidic gases. The solid stream 356 is melted by the heat from the melting device 344, resulting in a first product liquid stream 358 (e.g., 158). The vessel outlet 320 ((e.g., 120) is restricted, in this case by a valve 312, such that an internal pressure is maintained in the cavity of the vessel 302, the internal pressure being such that the solid stream 356 can transition directly from solid to liquid. The melting device 344 provides heat at a rate that matches the rate required to melt the solid stream 356. In some embodiments, the melting device 344 is a resistive heating element. In other embodiments, the melting device 344 is a tube through which a hot fluid is passed.

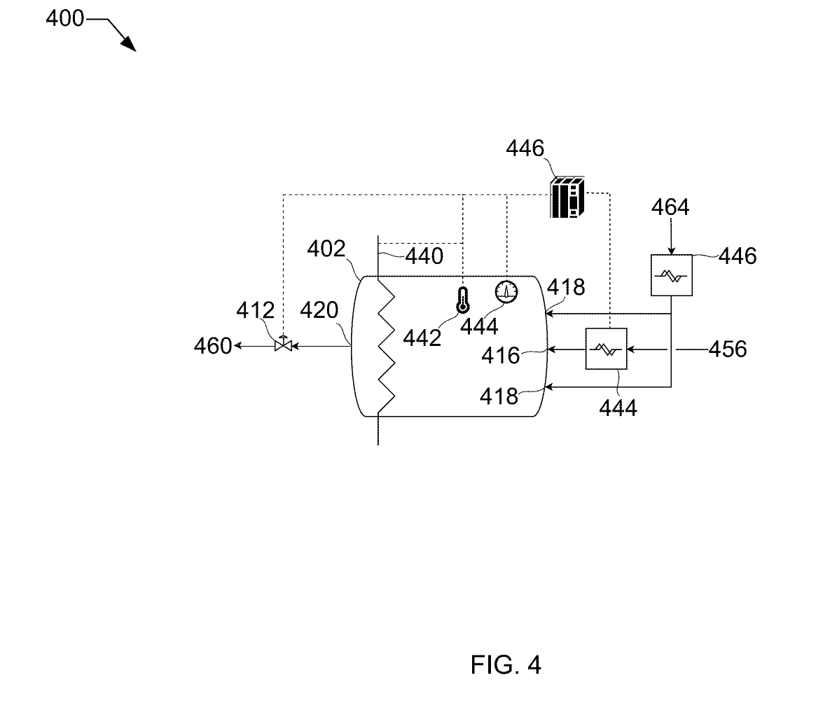

Referring to FIG. 4, FIG. 4 shows a process flow diagram 400 for melting solids that may be used in the described devices, systems, and methods. This method utilizes the energy sources of both FIGS. 1 and 3. A solid stream 456 (e.g., 156, 356) is passed through a flow meter 444 into the vessel 402 (e.g., 102, 302). A warm fluid stream 464 (e.g., 164, 364) passes through the vessel fluids inlet 418 (e.g., 118) into the vessel 402. The inlet pressure of the warm fluid stream 464 produces a backpressure on the solid stream 456. The flow meters 444 and 446 are shown as coriolis-style flow meters, but other flow meters may be used, as appropriate to the solid or fluid being measured. A melting device 440 provides a portion of the heat required for melting the solid stream 456. The warm fluid stream 464 encounters the solid stream 456 and provides the balance of the heat needed to melt the solid stream 456, resulting in a first product liquid stream 458 (e.g., 158, 358). The vessel outlet 420 ((e.g., 120, 320) is restricted, in this case by a valve 412 (e.g., 312), such that an internal pressure is maintained in the cavity of the vessel 402, the internal pressure being such that the solid stream 456 can transition directly from solid to liquid. The heating rate from the melting device 440 is controlled, along with the warm fluid stream 464 flow rate, to match the heating rate required to melt the solid stream 456. In some embodiments, the melting device 440 may be a resistive heating element. In other embodiments, the melting device 440 may be a tube through which a hot fluid is passed.

Pressure transmitter 442 and temperature transmitter 444 measure pressure and temperature, respectively, in vessel 402, and transmit the information to a process controller 446. Flow meters 444 and 446 measure flow in their respective streams and transmit this information to the process controller 446. Process controller 446 evaluates this information and then controls heating rates for melting device 440 and flow rates for solid stream 456 and warm liquid stream 464 and balances these against valve 412 to maintain pressure, temperature, and melting rate in vessel 402.

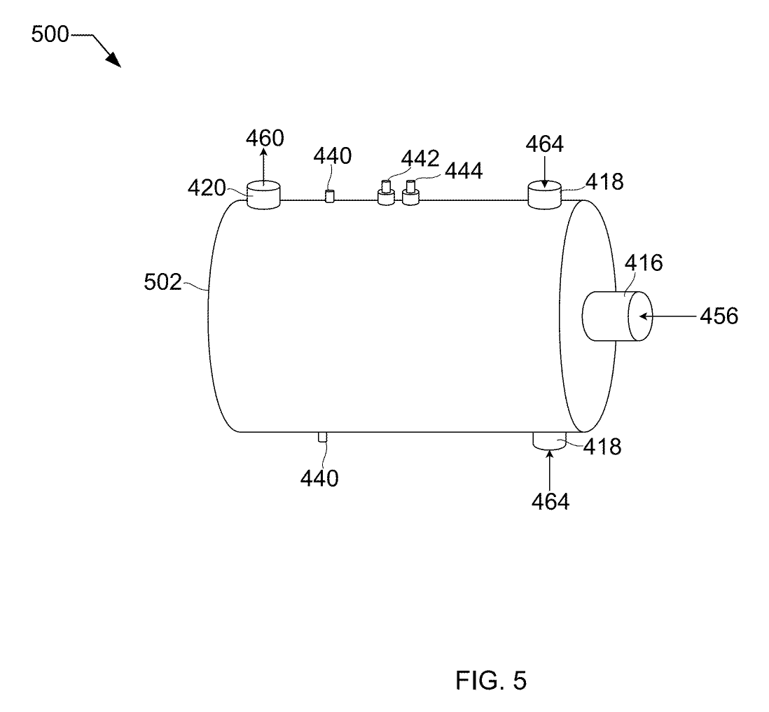

Referring to FIG. 5, FIG. 5 shows an isometric side-front elevation view 500 of a vessel that may be used in the described devices, systems, and methods. In this example, the vessel may be used in the process of FIG. 4, and will be described accordingly. Vessel 502 includes solids inlet 416, warm fluids inlets 418, vessel outlet 420, pressure transmitter 442, melting device 440, and temperature transmitter 444.

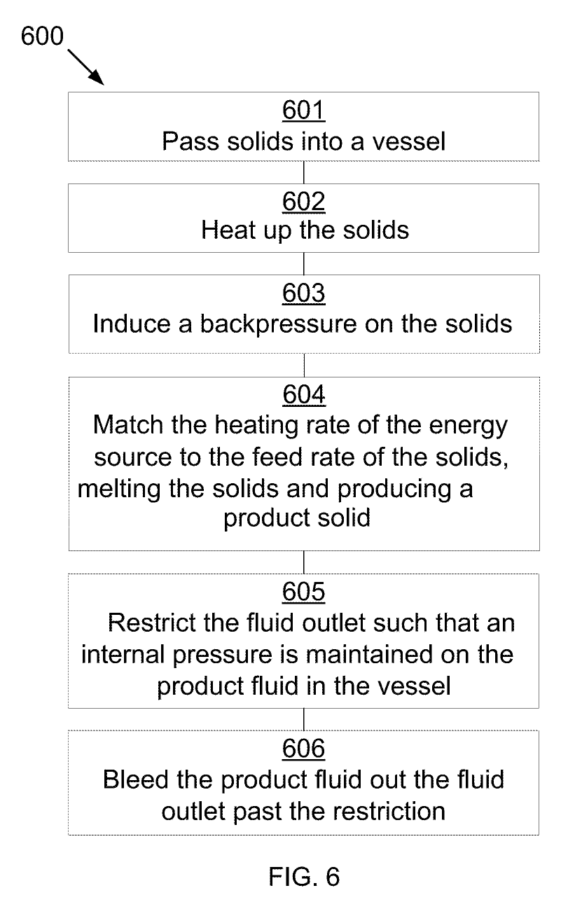

Referring to FIG. 6, FIG. 6 shows a method 600 for melting solids that may be used in the described devices, systems, and methods. At 601, solids are passed through a solids inlet into a vessel. The vessel includes the solids inlet, an energy source, a cavity, and a fluid outlet. At 602, an energy device heats up the solids. At 603, a backpressure is induced in the solids inlet. At 604, the heating rate of the energy source is matched to the feed rate of the solids such that the solids are melted, producing a product liquid. At 605, the fluid outlet is restricted such that an internal pressure is maintained in the cavity of the vessel, the internal pressure being such that the solids transition directly from solid to liquid. At 606, the product liquid is bled out the fluid outlet past the restriction.

In some embodiments, the solid and the warm liquid are the same compound. In other embodiments, the solid or liquid stream may include impurities or be varying mixtures of compounds.

In some embodiments, the solids may include water, hydrocarbons, ammonia, solid acid gases, or a combination thereof, and wherein solid acid gases comprise solid forms of carbon dioxide, nitrogen oxide, sulfur dioxide, nitrogen dioxide, sulfur trioxide, hydrogen sulfide, or a combination thereof.

In some embodiments, the warm liquid may include water, hydrocarbons, liquid ammonia, liquid acid gases, cryogenic liquids, or a combination thereof, and wherein liquid acid gases comprise liquid forms of carbon dioxide, nitrogen oxide, sulfur dioxide, nitrogen dioxide, sulfur trioxide, hydrogen sulfide, or a combination thereof.

1. A vessel comprising:
a solids inlet, the solids inlet directing solids into the vessel, wherein a backpressure is induced on the solids in the solids inlet;
a cavity, the cavity having an internal pressure;
an energy source, the energy source heating the vessel, contents of the cavity, or a combination thereof, wherein a rate of heating of the energy source is matched to a feed rate of the solids such that the solids are melted directly to a product liquid at the internal pressure; and
a fluids outlet, the fluids outlet directing the product liquid out of the vessel and the fluids outlet comprising a restriction that maintains the internal pressure of the cavity.

2. The vessel of claim 1, wherein the energy source comprises a melting device, a warm fluid, or a combination thereof.

3. The vessel of claim 2, wherein the solids inlet comprises a screw press.

4. The vessel of claim 2, wherein the fluids outlet comprises a heat exchanger, wherein the heat exchanger further heats the product liquid, producing a heated product liquid.

5. The vessel of claim 4, wherein the fluids outlet further comprises a gas/liquid separator, the gas/liquid separator receiving the heated product liquid from the heat exchanger, the heated product liquid becoming a final product liquid and a product gas, and separating the product gas from the final product liquid.

6. The vessel of claim 5, wherein the gas/liquid separator comprises a pump, the pump pumping a portion of the final product liquid from the gas/liquid separator to the vessel as the warm fluid, and an inlet pressure of the warm fluid contributes to the backpressure in the solids inlet.

7. The vessel of claim 2, wherein the solids inlet comprises a reducer, the reducer inducing the backpressure on the solids inlet.

8. The vessel of claim 1, wherein the restriction comprises one or more valves.

9. The vessel of claim 1, wherein the solids comprise water, hydrocarbons, ammonia, solid acid gases, or a combination thereof, and wherein solid acid gases comprise solid forms of carbon dioxide, nitrogen oxide, sulfur dioxide, nitrogen dioxide, sulfur trioxide, hydrogen sulfide, or a combination thereof.

10. The vessel of claim 1, wherein the warm liquid comprises water, hydrocarbons, liquid ammonia, liquid acid gases, cryogenic liquids, or a combination thereof, and wherein liquid acid gases comprise liquid forms of carbon dioxide, nitrogen oxide, sulfur dioxide, nitrogen dioxide, sulfur trioxide, hydrogen sulfide, or a combination thereof.

11. A method for melting solids comprising:
passing solids through a solids inlet into a vessel, wherein the vessel comprises the solids inlet, a fluid outlet, a cavity, and an energy source, and wherein the cavity has an internal pressure;
inducing a backpressure on the solids in the solids inlet;
heating the vessel, contents of the vessel, or a combination thereof, with the energy source;
matching a rate of heating of the energy source to a feed rate of the solids such that the solids are melted directly to a product liquid at the internal pressure; and
restricting the fluid outlet such that the internal pressure is maintained in the cavity;
bleeding the product liquid out the fluid outlet past the restriction.

12. The method of claim 11, wherein the energy source comprises a melting device, a warm fluid, or a combination thereof.

13. The method of claim 12, wherein at least a portion of the solids are a same compound as the warm liquid.

14. The method of claim 12, wherein the solids inlet comprises a screw press.

15. The method of claim 12, further comprising heating the product liquid through a heat exchanger, producing a heated product liquid.

16. The method of claim 15, further comprising passing the heated product liquid into a gas/liquid separator, resulting in a product gas and a final product liquid, and separating the product gas from the final product liquid.

17. The method of claim 16, further comprising pumping a portion of the final product liquid from the gas/liquid separator to the vessel, the portion of the final product liquid being the warm liquid.

18. The method of claim 12, wherein the restriction comprises one or more valves.

19. The method of claim 12, wherein the solids comprise water, hydrocarbons, ammonia, solid acid gases, or a combination thereof, and wherein solid acid gases comprise solid forms of carbon dioxide, nitrogen oxide, sulfur dioxide, nitrogen dioxide, sulfur trioxide, hydrogen sulfide, or a combination thereof.

20. The method of claim 12, wherein the warm liquid comprises water, hydrocarbons, liquid ammonia, liquid acid gases, cryogenic liquids, or a combination thereof, and wherein liquid acid gases comprise liquid forms of carbon dioxide, nitrogen oxide, sulfur dioxide, nitrogen dioxide, sulfur trioxide, hydrogen sulfide, or a combination thereof.
